(19) United States
(12) Patent Application Publication
(10) Pub. No.: US 2002/0057291 A1
(43) Pub. Date: May 16, 2002

(54) Method and system for providing service information on a server for a user device

(75) Inventors: Ying Chen, Beijing (CN); Dong Liu, Beijing (CN)

Correspondence Address: Douglas W. Cameron, Intellectual Property Law Dept., IBM Corporation, P.O. Box 218, Yorktown Heights, NY, 10598, US

(73) Assignee: International Business Machines Corporation, Armonk, NY

(21) Appl. No.: 09/991,834

(22) Filed: Nov. 6, 2001

(30) Foreign Application Priority Data
Nov. 13, 2000 (CN) 00132924.3

(51) Int. Cl. G09G 5/00

(52) U.S. Cl. 345/745

(57) ABSTRACT

A method and system for providing service information on a server for a user device is provided, comprising the steps of: inputting a user input command through a user device; transmitting the user input command to a command processing means, wherein the command processing means interprets the user input command and transmits it to the server; and providing the service information to the user device according to the user input command transmitted to the server. According to the method and system of the invention, it is easy to access a variety of information provided by a server through a user device, without being affected by its limited input capacity.

### DESCRIPTION

1. Technical Field

The present invention relates to a data service processing system and method, and more particularly to a system and method for providing service information on a server for a user device.

2. Description of the Prior Art

With the development of modem network, people have increasingly obtained various information services via network. For example, they are now able to obtain a variety of information from the world via Internet. On the other hand, owing to the fast development of wireless communication and electronic technology, mobile phone and many other portable devices have become very popular, and more and more people are beginning to access various information services through these wireless devices. A typical information service like digital map is being widely used. With the help of the digital map, people could make an inquiry via network to determine the location where he/she is at and his/her destination, etc. However, due to its small size, the number of input keys of a conventional mobile phone is limited, and moreover, for lack of pointing device such as mouse, the ability of a mobile phone which serves as a user device is restricted in respect of accessing information service, such as digital map information service.

### SUMMARY OF THE INVENTION

It is an object of the present invention to provide a method and system for providing service information on a server for a user device, so that the user device can easily access the information provided by the server through QWERTY keyboard without being affected by its limited input capacity.

A method for providing service information on a server for a user device is provided, the method comprising the steps of: inputting a user input command through a user device; transmitting the user input command to a command processing means; the command processing means interpreting the user input command and transmitting it to the server; and providing the service information for the user device according to the user input command transmitted to the server.

A system for providing service information on a server for a user device is provided, the system comprising: a user device for inputting a user input command; a command processing means for receiving and interpreting the user input command; and a server for providing the service information for the user device according to the user input command received from the command processing means.

According to the method and system of the invention, it is easy to access a variety of information provided by a server through a user device, such as mobile phone, without being affected by its limited input capacity.

### BRIEF DESCRIPTION OF THE DRAWINGS

The accompanying drawings, which are incorporated in and constitute a part of the invention, illustrate the embodiments of the present invention and explain the principles of the present invention, in conjunction with the description.

FIG. 1 is a system for providing service information on a server for a user device according to one embodiment of the present invention;

FIG. 2 is a flow chart for explaining the process of providing service information on a server for a user device;

FIG. 3 is a schematic diagram for explaining the type of user data stored in the database of a command processing means;

FIG. 4 is a schematic diagram for explaining the corresponding service mapping parameters in a user input command;

FIG. 5 is a system for providing service information on a server for a user device according to another embodiment of the present invent;

FIG. 6 is a flow chart for explaining the process of providing service information on a server for a user device as shown in FIG. 5.

### DETAILED DESCRIPTION OF THE INVENTION

A preferred embodiment of the present invention will now be described in details with reference to the accompanying drawings.

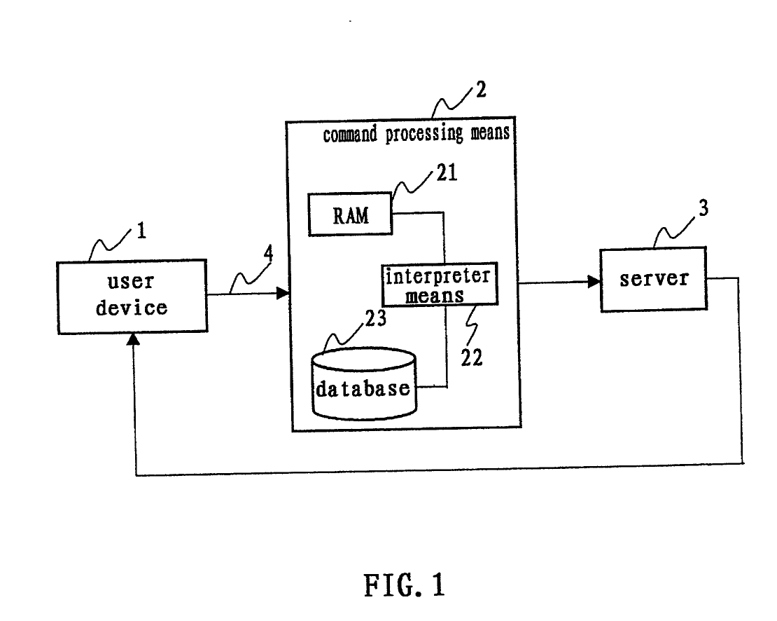

FIG. 1 shows a system for providing service information on a server to for user device according to an embodiment of the present invent.

In the example as depicted in FIG. 1, the system according to the present invention comprises a user device 1, a command processing means 2 and a server 3.

Referring to FIG. 1, a user input command is inputted to the user device 1 through a keyboard, a mouse or the like. The user device 1 may be a computer having a conventional keyboard or other devices with limited input capacity, such as mobile phone, Set-Top-Box, PDA or the like. To facilitate the description, the user device 1 in the present invention is a conventional mobile phone.

Referring to FIG. 1, the system according to the present invention further comprises a command processing means 2 for processing of the user input command, such as reading, storing, comparing and interpreting, etc.. The user input command inputted by the user device 1 is transmitted to the command processing means 2 through transmission line 4. It could be understood by those skilled in the arts that the transmission line 4 may be either wired connection line or wireless connection line.

The command processing means 2 as shown in FIG. 1 comprises a RAM (random access memory) 21 used for temporarily storing the user input command transmitted from the user device 1, and a database 23 where various data such as user identifier, the type of user device are stored. The command processing means further comprises an interpreter means, which is used for reading the user input command temporarily stored in RAM 21, and comparing the read user input command with the data stored in the database so as to interpret the user input command inputted by the user device.

In addition, the system according to the present invention, as depicted in FIG. 1, further comprises a server 3, on which a variety of service information such as map information are stored. The user device 1 can browse the content of the service information so as to find the desired location information accurately.

Now, the method for providing the map information on the server for the user device 1 according to the embodiment of the invention will be descried in details.

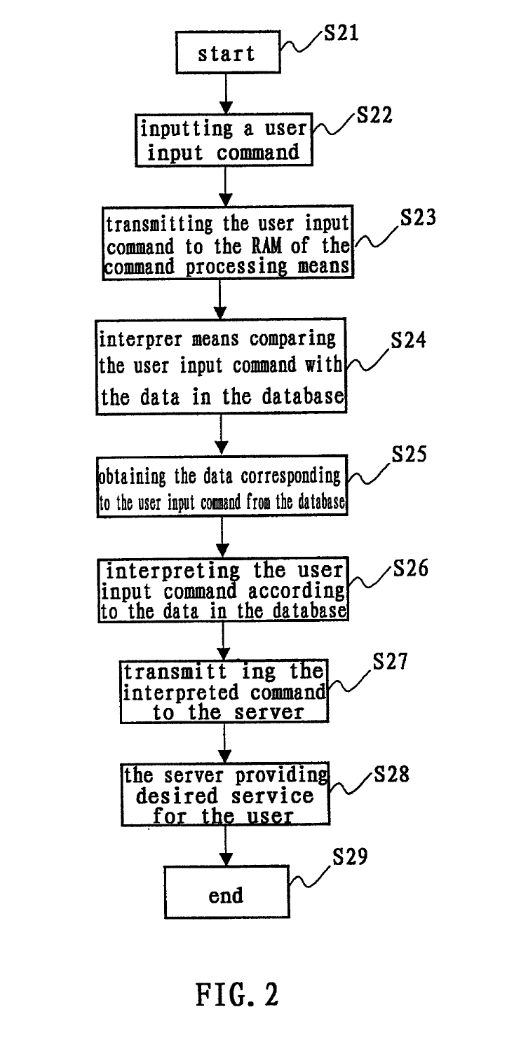

Referring to FIG. 2, the method according to the present invention starts at step S21. At step S22, a user inputs a user input command through the user device 1. As an example of the invention, the user device 1 as shown in FIG. 1 is a mobile phone. It is well known by those skilled in the arts that the number of input key of a mobile phone is limited due to its small size, its input capacity is accordingly limited, and moreover, for lack of pointing device such as mouse, the function of the mobile phone is restricted in respect of browsing map information. With regard to the above problem, the details on how the system according to the present invention provides the map information for the user device 1 will be described now.

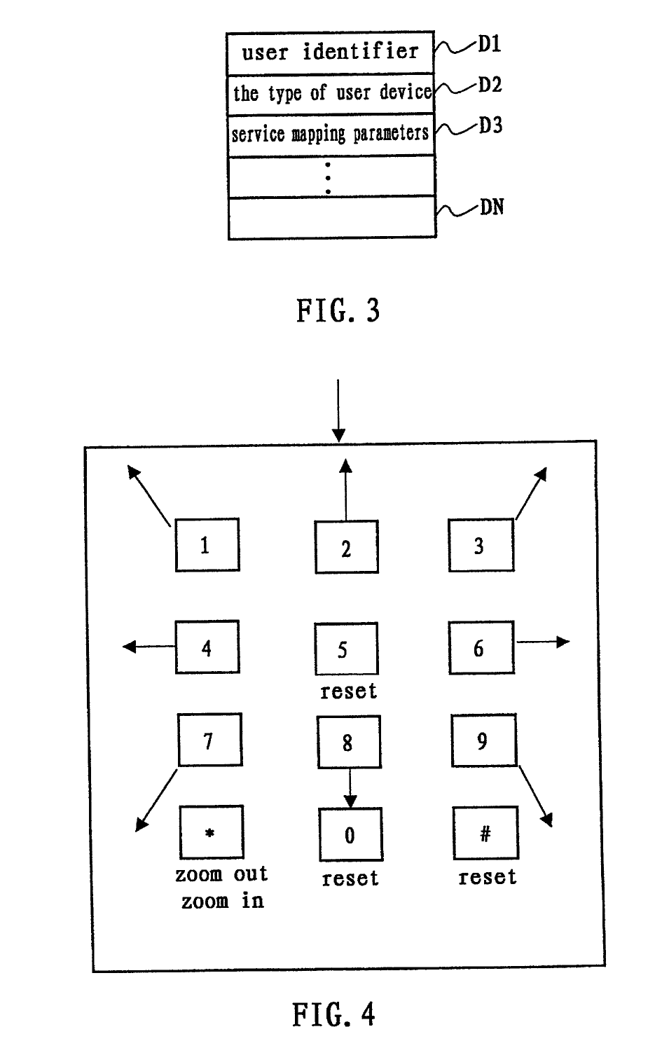

Referring back to step S22 as depicted in FIG. 2, after the user input command is inputted, the process proceeds to S23. At step S23, the user input command from the user device 1 is transmitted to the RAM 21 of the command processing means 2 for temporary storage. Then, the process proceeds to step S24. At step S24, the interpreter means 22 of the command processing means 2 first reads the user input command stored in the RAM 21. Next, the interpreter means 22 of the command processing means 2 accesses the user data stored in the database 23, and compares the user input command in the RAM 21 with the user data in the database 23. Then, the process proceeds to step S25. At step S25, the data corresponding to the user input command are obtained from the database. The types of the data stored in the database 23 will be described with reference to FIG. 3.

Further, following step S25, the process proceeds to step S26. At step S26, the interprets means 22 interpreters the corresponding user input command according to the data corresponding to the user input command, which is obtained from the database. Then, the process proceeds to step S27. At step S27, the command processing means 2 transmits the interpreted user input command to the server 3. Next, at step S28, the server 3 provides corresponding map information for the user device 1 according to the received interpreted user input command. In this way, the user device 1 is capable of browsing the map information provided on the server 3 according to the user input command thereof.

With reference to FIG. 3, the types of the data stored in the database 23 will be described now.

Referring to FIG. 3, it can be seen that the data included in the database 23 comprise a user identifier D1, the type of user device D2, service mapping parameter D3 and other parameter. The user identifier D1 is used for identifying the identity of the user who inputs a user input command. The type of user device D2 is used for indicating the type of the user device by which the user inputs the command, where the code 001 denotes a device having a QWERTY keyboard, the code 010 denotes a mobile phone, and the code 011 denotes a PDA, etc.. In addition, the service mapping parameter D3 is used for indicating the corresponding service provided by the server when the user input command inputted through the user device 1 has been mapped into the server.

According to the embodiment of the present invention, the mobile phone serving as the user device 1 is used for accessing the map service information provided by the server 3. It is well known that in order to perform the operations such as pan, zoom in/out, location (PZL) on the map information provided by the server, a mobile phone has to simulate the PZL operations on the basis of its present capacity, since it does not have a QWERTY keyboard and pointing device. The simulating PZL operations are implemented by using the service mapping parameters stored in the database. To facilitate the description on how the service mapping parameters D3 and mobile phone simulate PZL operation, a specific example is given in FIG. 4.

FIG. 4, shows the mapping relation represented by the service mapping parameters D3 in the database 23 and the PZL operations to be simulated. FIG. 4 illustrates an input keypad of a typical mobile phone. The input capacity of the input keypad of the mobile phone is limited due to the requirement for its size. In order to browse the map information provided by the server 3 with the existing keypad, the keypad function as shown in FIG. 4 may be mapped by the service mapping parameters D3. As shown in FIG. 4, the arrows represent the first function of the key pad, while the digits represent the second function of the key pad. The digit 1-4 and 6-9 represent the eight directions when navigating a digital map, while digit 5 represents the pan operation which is frequently used when locating features on a digital map. Thus, the user may press digit “6” to move the map to the right so as to browse the right section of the displayed digital map. Besides direction operations, digit key, combining with “#”, are also used for location operation.

As there is no pointing device like a mouse to locate features on a digital map, a grid is introduced in the screen of the mobile phone for easily locating on the screen of the mobile phone. For example, “#23” represents the (2, 3) cell in the grid, while “#56” represents the (5, 6) cell in the grid. Moreover, zoom in/out operation can be implemented by combining of “*” with digit key. For example, “*2” represents zooming out with the scale of 2, while “**8” represents zooming in with the scale of 8. As a result, the operations such as the zoom in/out, moving and locating can be easily performed by using the mapping relations represented by the service mapping parameters D3.

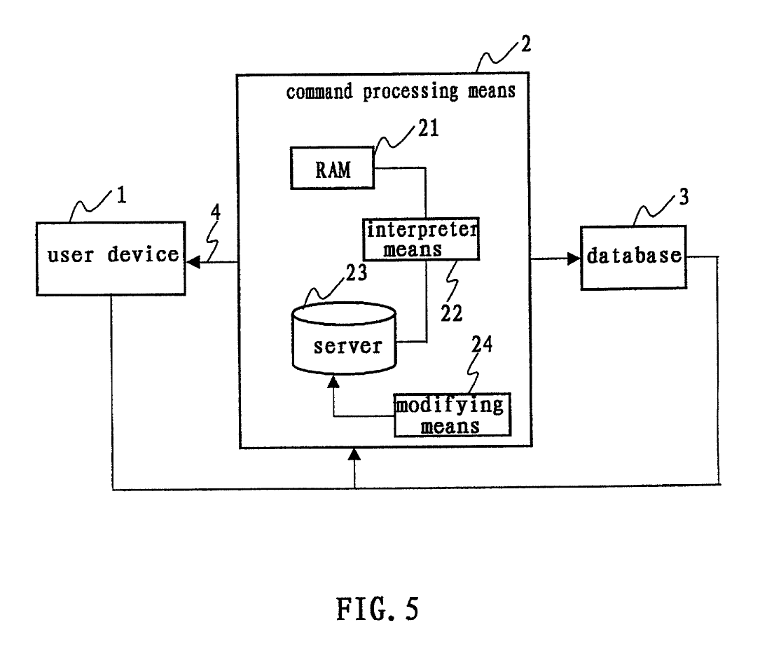

FIG. 5 illustrates a system for providing service information on a server for a user device according to another embodiment of the present invention.

In the description, similar means is denoted by the same reference numeral. In the embodiment as depicted in FIG. 5, the system according to the present invention also includes user device 1, command processing means 2 and server 3.

Referring to FIG. 5, the command processing means 2 included in the system is used for reading, storing, comparing and interpreting the user input command. The user input command input by the user device 1 is transmitted to the command processing means 2 via the transmission line 4. It could be understood by those skilled in the art that the transmission line 4 of the invention may be either a wired connection line or wireless connection line.

The command processing means 2 as depicted in FIG. 5 also includes a RAM (random access memory) 21 used for temporarily storing the user input command input from the user device, and a database 23 where various data such as user identifier, the type of user device are stored. The command processing means 2 further comprises an interpreter means, which is used for reading the user input command temporarily stored in RAM 21, and comparing the read user input command with the data stored in the database so as to interpret the user input command inputted by the user device 1. Moreover, the command processing means 2 as shown in FIG. 5 also includes a modifying means 24, which is used for receiving the input command from the user device 1 or the data from the server 3 so as to modify the data stored in the database 23. As a typical example, the user device 1 may modify a user identifier, the type of user device and service mapping parameters in the database 23 by means of the modifying means 24. Still taking the service mapping parameters as shown in FIG. 4 as an example, as the above described, “*2” represents zooming out with the scale of 2, while “**8” represents zooming in with the scale of 8. Through the modifying means 24 as shown in FIG. 5, the user device 24 can modify the service mapping parameters. For instance, after the modification, “#2” can be used to represent zooming out with the scale of 2, while “##8” be used to represent zooming in with the scale of 8. Thus, depending on its own requirements, the user device may easily access various information provided by the server by means of modifying the data stored in database.

Further, although the modifying means 24 as shown in FIG. 5 is included in the command processing means 2, the present invention is not limited to this. The modifying means according to the present invention may also be included in the server 3, and the service provider can make corresponding modifications to the data stored in the database by the modifying means 24 to meet user's requirements. The other means as shown in FIG. 5 will not be described since they have the same functions or purposes as those shown in FIG. 1.

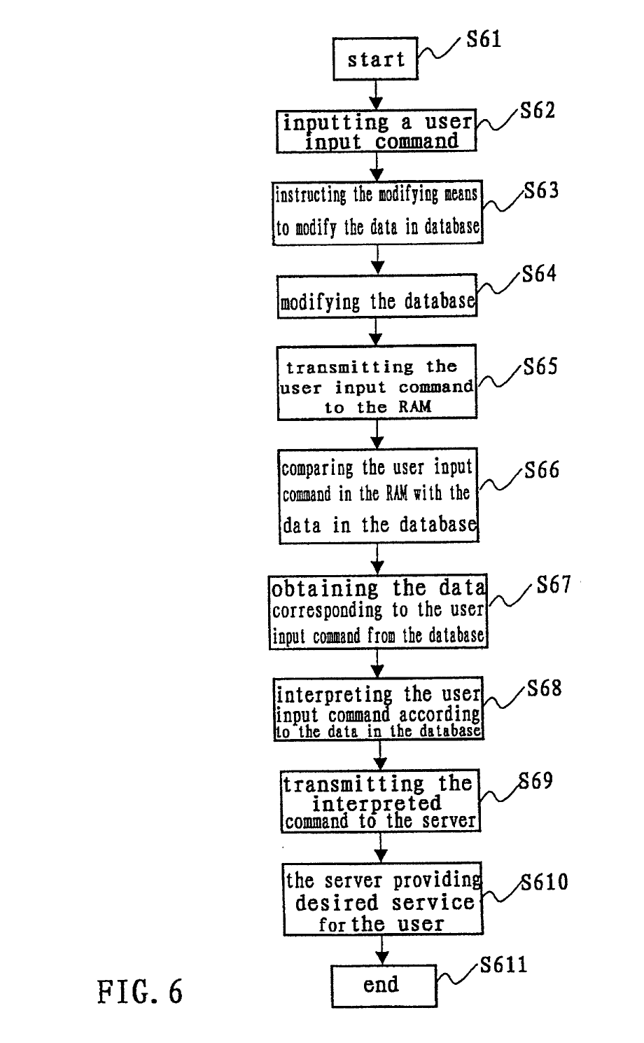

The method for providing map information on server 3 for the user device 1 according to the third embodiment of the present invention will now be described in details with reference to FIG. 6.

Referring to FIG. 6, the method according to the present invention starts at step S61. At step S62, a user inputs a user input command through the user device 1. As an example of the invention, the user device 1 as shown in FIG. 6 is a PDA. After the user input command has been inputted, the process proceeds to S63. At step S63, the user device 1 instructs the modifying means 24 to modify the data stored in the database 23 in the command processing means 2. At step S64, the modifying means 24 modifies the service mapping parameters or the like stored in the database 23. Then, the process proceeds to step S65. At step S65, the user input command from the user device 1 is transmitted to the RAM 21 of the command processing means 2 for the temporary storage. Then, the process proceeds to step S66. At step S66, the interpreter means 22 of the command processing means 2 reads the user input command stored in the RAM 21 at first. Then, the interpreter means 22 of the command processing means 2 accesses the user data prestored in the database 23 or the data having been modified, and comparing the user input command in the RAM 21 with the user data in the database 23. Then, the process proceeds to step S67. At step S67, the data corresponding to the user input command are obtained from the database. Then, the process proceeds to step S68. At step S68, the interpreter means 22 interprets corresponding user command according to the data corresponding to the user input commands, which are obtained from the database. Then, the process proceeds to step S69. At step S69, the command processing means 2 transmits the interpreted user input command to the server 3. Next, at step S610, the server 3 provides corresponding map information for the user device 1 according to the received user input command. In this way, the user device 1 is capable of browsing the map information provided on the server 3 according to the user input command thereof. Then, the process ends at step S611.

Various changes and modifications may be made without departing from the scope or spirit of the invention. It should be understood that the invention is not limited to particular embodiments, and the scope of the invention is defined by the appended claims.

Having thus described our invention, what we claim as new, and desire to secure by Letters Patent is:

1. A method for providing service information on a server for a user device, said method comprising the steps of:
inputting a user input command through said user device;
transmitting said user input command to a command processing means;
interpreting and transmitting said user input command to said server; and
providing the service information on said server for said user device on the basis of said user input command transmitted to said server.

2. A method for providing service information on a server for a user device as recited in claim 1, wherein an interpreter means of said command processing means reads user data stored in a database and interprets said user input command inputted by said user device.

3. A method for providing service information on a server for a user device as recited in claim 1, further comprising the steps of:
transmitting said user input command to a temporary storage unit of said command processing means; and
comparing said user input command stored in said temporary storage unit with the user data stored in the database to interpret said user input command inputted by said user device.

4. A method for providing service information on a server for a user device as claimed in claim 2, characterized in that it further comprising the step of modifying said user data stored in said database by said server.

5. A method for providing service information on a server for a user device as claimed in claim 2, characterized in that it further comprising the step of modifying said user data of said database by said user device.

6. A method for providing service information on a server for a user device as claimed in claim 2, wherein said user data of said database comprise user identifier, type of user device and service mapping parameters.

7. A method for providing service information on a server for a user device as claimed in claim 1, wherein said server provides a map information to said user device on the basis of said user input command transmitted to said server.

8. A method as recited in claim 1, wherein said input command is generated by pressing buttons on a keypad of a phone.

9. A system for providing service information on a server for a user device, said system comprising:
a user device for inputting the user input command;
a command processing means for interpreting said user input command and transmitting it to said server; and
a server for providing the service information on said server to said user device on the basis of said user input command transmitted to said server.

10. A system for providing service information on a server for a user device as recited in claim 9, said command processing means further comprises an interpreter means for interpreting said user input command inputted by said user device.

11. A system for providing service information on a server for a user device as recited in claim 9, wherein said server further comprises a temporary storage unit for temporarily storing said user input command.

12. A system for providing service information on a server for a user device as recited in claim 10, wherein said server further comprises a database for storing user data.

13. A system for providing service information on a server for a user device as claimed in claim 12, wherein said server further comprises a modifying means for modifying said user data in said database.

14. A system for providing service information on a server for a user device as recited in claim 13, wherein said modifying means is included in said command process means, said user device modifies said user data of said database through said modifying means.

15. A system for providing service information on a server for a user device as recited in claim 13, wherein said modifying means is included in said server, said server modifies said user data of said database through said modifying means.

16. A system for providing service information on a server for a user device as recited in claim 10, wherein said user data of said database comprise user identifier, type of user device and service mapping parameters.

17. A system for providing service information on a server for a user device as recited in claim 9, wherein said server provides a map information to said user device on the basis of said user input command transmitted to said server.

18. A system for providing service information on a server for a user device as recited in claim 9, wherein said user device is a device with a QWERTY keyboard.

19. A system for providing service information on a server for a user device as recited in claim 9, wherein said user device is a device with a limited input capability.

20. A system for providing service information on a server for a user device as recited in claim 9, wherein said user device is one of a mobile phone, a PDA or a Set-Top-Box.

21. A system for providing service information as recited in claim 9, wherein said user device is a phone.

22. In a system for providing service information from a server to a user device, a program storage device readable by said system, tangibly embodying a program of instructions executable by said system to perform method steps for providing service information to said user device, said method steps comprising:
receiving input commands from said user device;
interpreting said input commands and transmitting them to said server; and
providing said service information from said server to said user device in accordance with said input commands received.

23. A program storage device as recited in claim 22, wherein said user device is a phone from which commands can be sent by pressing buttons on a keypad of said phone.
